(19) United States
(12) Patent Application Publication
(10) Pub. No.: US 2024/0180671 A1
(43) Pub. Date: Jun. 6, 2024

(54) GENERATING ALIGNERS WITH VARIANT MECHANICAL PROPERTIES

(71) Applicant: SDC U.S. SmilePay SPV, Nashville, TN (US)

(72) Inventors: Drew Marschner, Nashville, TN (US); Charlotte Xia, Nashville, TN (US); Jordan Sutton, Nashville, TN (US); Tim Wucher, Windhoek (NA); Justin Kreil, Nashville, TN (US); John Dargis, Nashville, TN (US); Eric Wagnon, Nashville, TN (US); Ryan Ogletree, Nashville, TN (US); Cherie Wilson, Nashville, TN (US)

(73) Assignee: SDC U.S. SmilePay SPV, Nashville, TN (US)

(21) Appl. No.: 18/074,954

(22) Filed: Dec. 5, 2022

(51) Int. Cl. A61C 7/08; A61C 7/00; B29C 51/14

(52) U.S. Cl. CPC A61C 7/08; A61C 7/002; B29C 51/14

(57) ABSTRACT

A method may include generating a 2D blank that can form a 3D dental aligner via thermoforming. The 2D blank may include a first material that includes a first discontinuity. The 2D blank may include a second material integrally formed within the first discontinuity. The first material may have a higher stiffness than the second material. The method may include thermoforming the 2D blank to form the 3D dental aligner having variable stiffness.

### TECHNICAL FIELD

The present disclosure relates generally to the field of dental appliances. More specifically, the present disclosure relates to systems and methods for forming a dental appliance with spatially variant mechanical properties.

### BACKGROUND

Dental aligners generated from physical or digital reproductions of a patient's teeth can be used by oral care professionals (e.g., dentists, orthodontists) to treat misalignment of the patient's teeth by repositioning the patient's teeth. Effectiveness of the treatment may often be affected by how well the dental aligner controls movement of each of the patient's teeth such that the dental aligner moves the patient's teeth as specified by a treatment plan. Accordingly, it would be advantageous to provide systems and methods for generating a dental aligner with spatially variant mechanical properties to enhance control of force between the dental aligner and the patient's teeth to move the patient's teeth with greater efficiency and accuracy, and to ensure the patient's teeth move according to their treatment plan.

### SUMMARY

One embodiment of the present disclosure relates to a method of forming a dental aligner. The method may include generating a 2D blank that can form a 3D dental aligner via thermoforming. The 2D blank may include a first material that includes a first discontinuity. The 2D blank may include a second material integrally formed within the first discontinuity. The first material may have a higher stiffness than the second material.

Another aspect of the present disclosure relates to a 2D blank for forming a 3D dental aligner. The 2D blank may include a first material that includes a first discontinuity. The 2D blank may include a second material integrally formed within the first discontinuity. The first material may have a higher stiffness than the second material. The 2D blank may be thermoformed to form the 3D dental aligner.

Yet another aspect of the present disclosure relates to a system. The system may include a cutting apparatus that can form a first discontinuity through at least a portion of a first material. The system may include a stamping apparatus that can cut a 2D blank out of the first material. The system may include a molding apparatus that can integrally mold a second material into the first discontinuity of the 2D blank. The first material may have a higher stiffness than the second material. The 2D blank may be thermoformed to form a 3D dental aligner.

Various other embodiments and aspects of the disclosure will become apparent based on the drawings and detailed description of the following disclosure.

### BRIEF DESCRIPTION OF THE FIGURES

FIG. 1 is a system for orthodontic treatment including a treatment planning computer system, according to an exemplary embodiment.

FIG. 2 is a schematic of a process of generating a 3D orthodontic aligner, according to an exemplary embodiment.

FIG. 3 is an example of a 3D orthodontic aligner, according to an exemplary embodiment.

FIG. 4 is a flow chart of a process of generating a 2D blank for an orthodontic aligner, according to an exemplary embodiment.

FIG. 5 is an example of a 2D blank configured to form a 3D orthodontic aligner, according to an exemplary embodiment.

FIG. 6 is a flow chart of a process of generating a 2D blank for an orthodontic aligner, according to an exemplary embodiment.

FIGS. 7A-7C are schematic examples of welding processes, according to an exemplary embodiment.

FIG. 8 is a flow chart of a process of generating a 2D blank for an orthodontic aligner, according to an exemplary embodiment.

FIG. 9 is a flow chart of a process of generating a 2D blank for an orthodontic aligner, according to an exemplary embodiment.

FIG. 10 is a flow chart of a process of generating a 2D blank for an orthodontic aligner, according to an exemplary embodiment.

FIG. 11 is a flow chart of a process of generating a 2D blank for an orthodontic aligner, according to an exemplary embodiment.

FIG. 12 is a flow chart of a process of generating a 2D blank for an orthodontic aligner, according to an exemplary embodiment.

FIG. 13 is a flow chart of a process of generating a 2D blank for an orthodontic aligner, according to an exemplary embodiment.

FIGS. 14A-14C are example schematics of a process of generating a 2D blank for an orthodontic aligner, according to an exemplary embodiment.

FIGS. 15A-15C are example schematics of a process of generating a 2D blank for an orthodontic aligner, according to an exemplary embodiment.

FIGS. 16A-16C are example schematics of a process of generating a 2D blank for an orthodontic aligner, according to an exemplary embodiment.

FIGS. 17A and 17B are example schematics of a process of generating a 2D blank for an orthodontic aligner, according to an exemplary embodiment.

FIGS. 18A and 18B are examples of portions of a model of an orthodontic aligner, according to an exemplary embodiment.

FIG. 19 is a flow chart of a process of generating a 3D orthodontic aligner, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

As described above, orthodontic appliances or devices (e.g., aligners) may be used to treat misalignment of teeth by applying one or more forces to individual teeth, which causes the teeth to adjust their relative position within an oral cavity when one or more forces are applied over time. To effectively and efficiently apply the one or more forces, it is advantageous that the aligner exhibits spatially variant mechanical properties such that the aligner effectively applies variable force in predetermined directions to effectuate sufficient movement of particular teeth. Conventional techniques of forming an aligner may typically involve laminating multiple materials into uniform multi-ply structures that will not have spatially variant properties. Therefore, none of these techniques may be used to create 2D thermoforming substrates with spatially variant mechanical properties. Accordingly, the present disclosure relates to systems and methods for generating a single-ply or multi-ply, multiple material 2D thermoforming substrate that exhibits spatially variant mechanical properties.

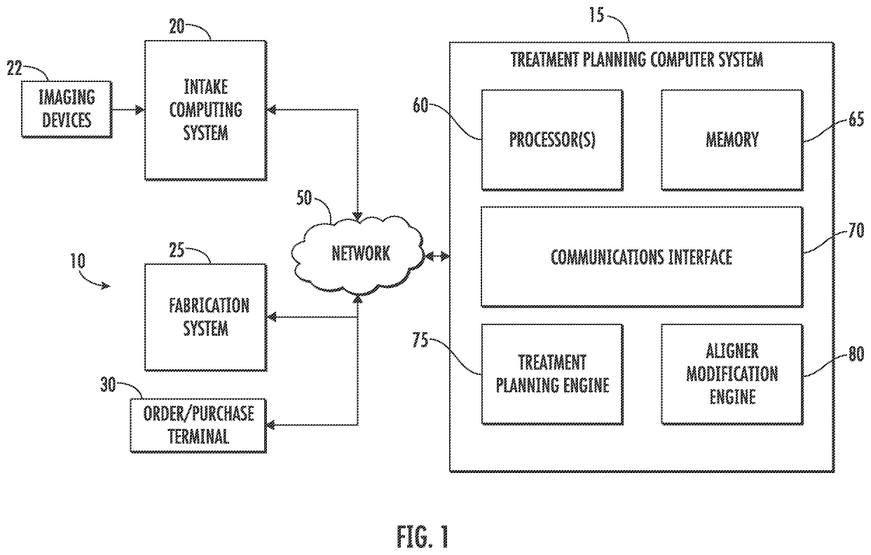

Referring to FIG. 1, a system 10 for orthodontic treatment is shown, according to an exemplary embodiment. As shown in FIG. 1, the system 10 includes a treatment planning computer system 15 communicably coupled to an intake computing system 20, and a fabrication system 25. In some embodiments, the treatment planning computer system 15 may be or may include one or more servers which are communicably coupled to a plurality of computing devices. In some embodiments, the treatment planning computer system 15 may include a plurality of servers, which may be located at a common location (e.g., a server bank) or may be distributed across a plurality of locations. The treatment planning computer system 15 may be communicably coupled to the intake computing system 20, fabrication system 25, and order/purchase terminal 30, via a communications link or network 50 (which may be or include various network connections configured to communicate, transmit, receive, or otherwise exchange data between addresses corresponding to the computing systems 15, 20, 25, 30). The network 50 may be a Local Area Network (LAN), a Wide Area Network (WAN), a Wireless Local Area Network (WLAN), an Internet Area Network (IAN) or cloud-based network, etc. The network 50 may facilitate communication between the respective components of the system 10, as described in greater detail below.

The computing systems 15, 20, 25, 30 include one or more processing circuits, which may include processor(s) 60 and memory 65. The processor(s) 60 may be a general purpose or specific purpose processor, an application specific integrated circuit (ASIC), one or more field programmable gate arrays (FPGAs), a group of processing components, or other suitable processing components. The processor(s) 60 may be configured to execute computer code or instructions stored in memory 65 or received from other computer readable media (e.g., CDROM, network storage, a remote server, etc.) to perform one or more of the processes described herein. The memory 65 may include one or more data storage devices (e.g., memory units, memory devices, computer-readable storage media, etc.) configured to store data, computer code, executable instructions, or other forms of computer-readable information. The memory 65 may include random access memory (RAM), read-only memory (ROM), hard drive storage, temporary storage, non-volatile memory, flash memory, optical memory, or any other suitable memory for storing software objects and/or computer instructions. The memory 65 may include database components, object code components, script components, or any other type of information structure for supporting the various activities and information structures described in the present disclosure. The memory 65 may be communicably connected to the processor 60 via the processing circuit, and may include computer code for executing (e.g., by processor(s) 60) one or more of the processes described herein.

The treatment planning computer system 15 is shown to include a communications interface 70. The communications interface 70 can be or can include components configured to transmit and/or receive data from one or more remote sources (such as the computing devices, components, systems, and/or terminals described herein). In some embodiments, each of the servers, systems, terminals, and/or computing devices may include a respective communications interface 70 which permit exchange of data between the respective components of the system 10. As such, each of the respective communications interfaces 70 may permit or otherwise enable data to be exchanged between the respective computing systems 15, 20, 25, 30. In some implementations, communications device(s) may access the network 50 to exchange data with various other communications device(s) via cellular access, a modem, broadband, Wi-Fi, satellite access, etc. via the communications interfaces 70.

The treatment planning computer system 15 is shown to include a plurality of engines, including a treatment planning engine 75 and an aligner modification engine 80. The treatment planning engine 75 and the aligner modification engine 80 may be any device(s), component(s), circuit(s), or other combination of hardware components designed or implemented to receive inputs for and/or automatically generate a treatment plan implementing dental appliances (e.g., dental aligners configured to reposition one or more teeth of the patient) including surfaces configured to reposition one or more teeth of the patient efficiently. In some embodiments, the treatment planning engine 75 and the aligner modification engine 80 may be instructions stored in memory 65 which are executable by the processor(s) 60. In some embodiments, the treatment planning engine 75 and the aligner modification engine 80 may be stored at the treatment planning computer system 15 and accessible via a respective treatment planning terminal.

The intake computing system 20 may be configured to generate a 3D model (e.g., a 3D digital model) of a dentition. In some embodiments, the intake computing system 20 may be communicably coupled to or otherwise include one or more imaging devices 22 configured to generate, capture, or otherwise produce a 3D model of an object, such as a dentition or dental arch. In some embodiments, the imaging devices 22 may include intraoral scanners configured to generate a 3D model of a dentition of a patient as the intraoral scanner passes over the dentition of the patient. For example, the intraoral scanner may be used during an intraoral scanning appointment, such as the intraoral scanning appointments described in U.S. Provisional Patent Application No. 62/660,141, titled “Arrangements for Intraoral Scanning,” filed Apr. 19, 2018, and U.S. patent application Ser. No. 16/130,762, titled “Arrangements for Intraoral Scanning,” filed Sep. 13, 2018, the contents of each of which are incorporated herein by reference in their entirety. In some embodiments, the imaging devices 22 may include 3D scanners configured to scan a dental impression. The dental impression may be captured or administered by a patient using a dental impression kit similar to the dental impression kits described in U.S. Provisional Patent Application No. 62/522,847, titled “Dental Impression Kit and Methods Therefor,” filed Jun. 21, 2017, and U.S. patent application Ser. No. 16/047,694, titled “Dental Impression Kit and Methods Therefor,” filed Jul. 27, 2018, the contents of each of which are incorporated herein by reference in their entirety. In these and other embodiments, the imaging devices 22 may generally be configured to generate a 3D model of a dentition of a patient. As an example, the 3D model may be a point cloud representation of the dentition, a voxel representation, a spline representation, a mesh representation, or any other parametric model representation. In some embodiments, the imaging devices 22 may be configured to capture a two dimensional (2D) image of a dentition of the patient that is then converted into a 3D model. For example, the imaging devices 22 can be a user device, such as a mobile device, such as a smartphone, tablet, or camera. The imaging devices 22 may be configured to generate a 3D model of the upper (i.e., maxillary) dentition and/or the lower (i.e., mandibular) dentition of the patient. One or more 2D images can be converted into a digital model using any of the systems and processes disclosed in U.S. patent application Ser. No. 16/696,468, titled “Systems and Methods for Constructing a Three-Dimensional Model from Two-Dimensional Images,” filed Nov. 26, 2019, and U.S. patent application Ser. No. 17/247,055, titled “Systems and Methods for Constructing a Three-Dimensional Model from Two-Dimensional Images,” filed Nov. 25, 2020, the contents of each of which are incorporated herein by reference in their entirety. The 3D model may include a digital representation of the patient's teeth and/or gingiva. The imaging devices 22 may be configured to generate 3D models of the patient's dentition prior to treatment (i.e., with their teeth in an initial position). In some embodiments, the imaging devices 22 may be configured to generate the 3D models of the patient's dentition in real-time (e.g., as the dentition/impression is imaged). In some embodiments, the imaging devices 22 may be configured to export, transmit, send, or otherwise provide data obtained during the imaging to an external source which generates the 3D model, and transmits the 3D model to the intake computing system 20.

The intake computing system 20 may be configured to transmit, send, or otherwise provide the 3D model to the treatment planning computer system 15. In some embodiments, the intake computing system 20 may be configured to provide the 3D model of the patient's dentition to the treatment planning computer system 15 by uploading the 3D model to a patient file for the patient. The intake computing system 20 may be configured to provide the 3D model of the patient's upper and/or lower dentition at their initial (i.e., pre-treatment) position. The 3D model of the patient's upper and/or lower dentition may together form initial imaging data which represents an initial position of the patient's teeth prior to treatment.

The treatment planning engine 75 may be configured to generate a treatment plan based on or using the 3D model created from the imaging data. The treatment planning engine 75 may be configured to modify, correct, adjust, or otherwise process the initial imaging data or 3D model received from the intake computing system 20 prior to generating a treatment plan. The treatment planning engine 75 may be configured to define a gingival line of the 3D model such that the teeth can be separated from the gingiva shown in the 3D model. The gingival line may be defined as the juncture or interface between the teeth portion and the gingiva portion of the model. The treatment planning engine 75 may be configured to segment individual teeth from the tooth model to separate the teeth from one another. The treatment planning engine 75 may be configured to identify the teeth and gingiva (e.g., gum) portions of the 3D model. For example, the teeth portion of the model correspond to the teeth of the patient's dentition, and the gingiva portion of the model correspond to a portion of the gingiva of the patient's dentition. The treatment planning engine 75 may be configured to identify various characteristics within the model which are consistent with the teeth portion, such as surface contours of crowns, separation or gaps in the interproximal region (e.g., the space between the teeth portion), and/or the like. In some embodiments, the treatment planning engine 75 may be configured to identify the teeth portion within the model, and other portions of the model that are not identified as the teeth portion may be identified as the gingiva portion of the model. In some embodiments, the treatment planning engine 75 may be configured to generate an object (OBJ) file including each of the teeth and gingiva portions, with each of the teeth and gingiva portions being represented as separate objects within the OBJ file.

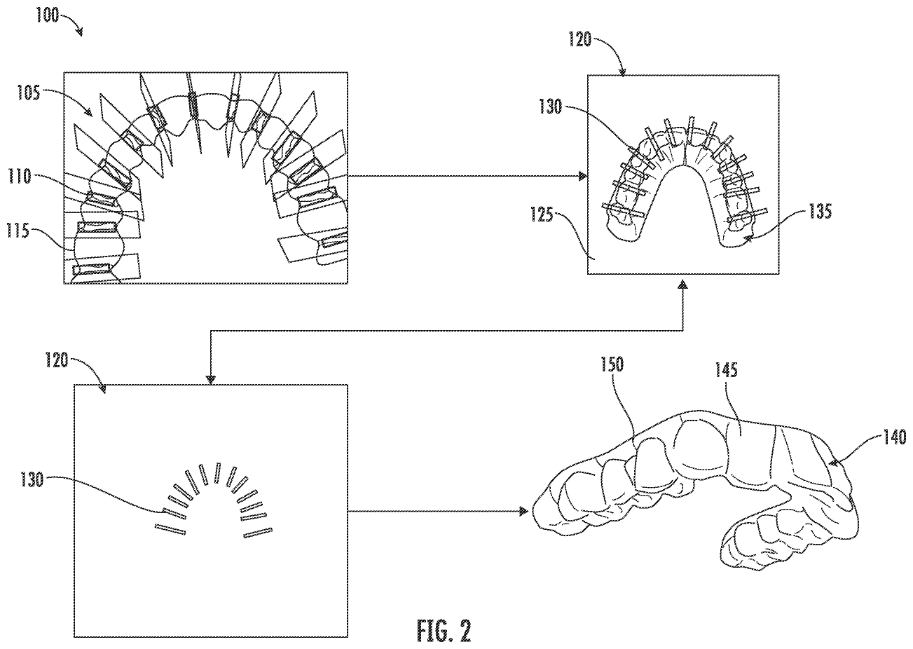

The treatment planning engine 75 may be configured to generate stages of treatment (e.g., a treatment plan) for one or more of the patient's teeth to move relative to one another from an initial position to a final position. As part of staging, the treatment planning engine 75 may be configured to generate a plurality of staged 3D models 105 (e.g., as shown and described in FIG. 2) corresponding to the treatment plan for the patient. Each 3D model 105 may be representative of a particular stage of the treatment plan (e.g., a first 3D model 105 corresponding to an initial stage of the treatment plan, one or more intermediate 3D models 105 corresponding to intermediate stages of the treatment plan, and a final 3D model 105 corresponding to a final stage of the treatment plan).

The aligner modification engine 80 may be configured to determine and select modifications to be made to the dental aligners to cause the dental aligners to grip the teeth, and therefore exert a sufficient force on the teeth, intended to be repositioned according to the treatment plan. The aligner modification engine 80 may be configured to analyze the digital or physical representation of the teeth to determine at least one tooth among the patient's teeth that is to be repositioned and determine a corresponding location on the teeth for applying a force to effectuate movement of the at least one tooth.

The aligner modification engine 80 may be configured to determine corresponding locations within an aligner to apply one or more forces to the teeth or resist movement of the teeth to facilitate positional adjustment thereof. The aligner modification engine 80 may be configured to select a desired type of material for each of the one or more locations within the aligner where a force is to be applied or movement of the teeth is to be increased or decreased within the aligner. The aligner modification engine 80 may be configured to select the desired type of material by determining a particular magnitude and direction of one or more forces applied to particular teeth. For example, one or more elastic materials integrally bonded into one or more discontinuities formed in a rigid material may increase, decrease, or effectively control (e.g., magnitude and/or trajectory) the amount of force exerted on one or more teeth as compared to an aligner formed from a single material of a uniform stiffness. The effective force magnitude within the physiological range exerted on one or more teeth can be controlled by the dimension, shape and number of elastic material regions. For example, the elastic materials may fill in one, a few or all interproximal regions. In some embodiments, the pressures generated by the orthodontic aligners in the periodontal ligament is between 1.0 to 2.5 kPa (10±25 g/cm²) and as such is within the physiological range. In some embodiments, the forces applied by the orthodontic aligners meet or exceed the maximum rate of bone turnover. For example, the elastic materials described herein can press, pull, or otherwise deform one or more discontinuities formed within the rigid materials described herein by stretching, bending, flexing, or pulling the rigid material within the discontinuities. Such movements can cause a change in force exerted on the one or more teeth by the rigid material of the aligner.

The treatment planning computer system 15 may be configured to transmit, send, or otherwise provide the staged 3D models 105 including modifications determined by the aligner modification engine 80 to the fabrication system 25. In some embodiments, the treatment planning computer system 15 may be configured to provide the staged 3D models 105 and the modifications to the fabrication system 25 by uploading the staged 3D models 105 and modifications to a patient file which is accessible via the fabrication system 25. In some embodiments, the treatment planning computer system 15 may be configured to provide the staged 3D models 105 and modifications to the fabrication system 25 by sending the staged 3D models 105 and modifications to an address (e.g., an email address, IP address, etc.) for the fabrication system 25.

The fabrication system 25 can include a fabrication computing device and fabrication equipment configured to produce, manufacture, or otherwise fabricate dental aligners. The fabrication system 25 may be configured to receive a plurality of staged 3D models 105 and modifications corresponding to the treatment plan for the patient. The fabrication system may be configured to send the staged 3D models 105 and modifications to fabrication equipment for generating, constructing, building, or otherwise producing dental aligners that can be worn by the patient to reposition one or more teeth of the patient. The fabrication equipment may include a thermoforming system as described herein. The thermoforming system may be configured to thermoform a polymeric material to the physical models, and cut, trim, or otherwise remove excess polymeric material from the physical models to fabricate a dental aligner. Additional details corresponding to fabricating dental aligners are described in U.S. Provisional Patent Application No. 62/522,847, titled “Dental Impression Kit and Methods Therefor,” filed Jun. 21, 2017, and U.S. patent application Ser. No. 16/047,694, titled “Dental Impression Kit and Methods Therefor,” filed Jul. 27, 2018, and U.S. patent application Ser. No. 16/188,570, titled “Systems and Methods for Thermoforming Dental Aligners,” filed Nov. 13, 2018, the contents of each of which are incorporated herein by reference in their entirety.

The order/purchase terminal 30 may include any device(s), component(s), circuit(s), or other combination of hardware components designed or implemented to complete and/or guide a user in placing an order. An order may be a transaction that exchanges money from a patient for a product (e.g., an impression kit, dental aligners, etc.). The order/purchase terminal 30 may communicate with the fabrication system 25 and third party device (e.g., a patient device or other user device) to guide a patient or other user through a payment/order completion system without requiring the patient to order through a traditional dentist office. In some embodiments, the order/purchase terminal 30 may communicate prompts to the user device to guide the user through the payment/order completion system. The prompts may include asking the patient for patient information (e.g., name, physical address, email address, phone number, credit card information) and product information (e.g., quantity of product, product name). In response to receiving information from the patient, the order/purchase terminal 30 initiates a product order. In some embodiments, an order may be placed by or in collaboration with a traditional dentist or orthodontist office. For example, the order may be a transaction that exchanges money from a doctor's office or insurance organization for a product (e.g., an impression kit, dental aligners, etc.). The order/purchase terminal 30 may communicate with the fabrication system 25 and third party device (e.g., a computer device corresponding to a doctor's office or insurance organization) to guide a user through a payment/order completion system. In response to receiving the order, the order/purchase terminal 30 initiates a product order. The initiated product order is transmitted to the fabrication system 25 to initiate the fabrication of one or more products (e.g., dental aligners). The initiated product order may also be transmitted to the intake computing system 20 to store/record the transaction and/or to initiate a product order from the computing system (e.g., a dental impression kit, dental aligners, etc.), and the like.

Referring to FIG. 2, a schematic of an overview of a process 100 for generating a dental aligner is shown, according to an exemplary embodiment. As shown in FIG. 2, the process 100 may include receiving a model of a dental aligner (e.g., a staged 3D digital model 105 generated by the treatment planning engine 75 described herein) that is to be fabricated for a patient. For example, the digital model 105 of the dental aligner may correspond to at least one stage of the treatment plan generated by the treatment planning computer system 15 described herein. The model 105 may include one or more modeled soft material regions 110 and one or more modeled rigid material regions 115 of the dental aligner. As described herein, the modeled soft material regions 110 may represent locations of corresponding discontinuities within the modeled rigid material regions 115 in which soft material may be integrally formed within. For example, the combination of rigid material regions and soft material regions may facilitate applying forces in variable magnitude and direction on specific teeth to adjust the position of the specific teeth. As shown in FIG. 2, in some embodiments, the modeled soft material regions 110 may be located at an interproximal region between one or more teeth and the modeled rigid material regions 115 may be located at one or more positions on the model 105 that are configured to receive and/interface with a surface of a tooth.

The process 100 may include forming a 2D blank 120 (e.g., a 2D single-ply or multiple layer sheet of one or more materials) that can be used to form a 3D dental aligner based on the model 105. Forming the 2D blank 120 will be described in greater detail herein. The 2D blank 120 may include at least one rigid material 125 having one or more discontinuities 130 (e.g., cuts, patterns, spaces, etches, openings, etc.) in which soft material can be integrally formed within. For example, the rigid material 125 may correspond to the modeled rigid material regions 115 of the model 105 and the discontinuities 130 may correspond to the modeled soft material regions 110. The 2D blank 120 may be configured to be overlaid onto a dental dentition mold 135 formed in accordance with the generated treatment plan that may serve as a thermoforming mold to form the 3D dental aligner corresponding to the model 105. For example, the dental dentition mold 135 may correspond to a mold or 3D model of a patient's dentition at least at one stage of the generated treatment plan. In some embodiments, the process 100 may include one or more techniques to ensure the discontinuities 130 in the rigid material 125 of the 2D blank 120 accurately match the modeled soft material regions 110 of the digital model 105. For example, the rigid material 125 may be projected onto or overlaid relative to the dental dentition mold 135 and/or compared with the digital model 105 to determine whether the discontinuities 130 match the modeled soft material regions 110. As used herein, “rigid” materials may have a modulus from about 500 MPa to about 4000 MPa and/or may be or may include any substantially rigid substrates including, but not limited to, a polyester or a co-polyester, a rigid polyurethane, a polycarbonate, a polyolefin, a polyamide, an acrylic copolymer, a styrenic block copolymer, or other rigid polymers or plastics.

The process 100 may including filling in one or more of the discontinuities 130 of the rigid material 125 with one or more soft materials. For example, as described in greater detail herein, the discontinuities in the at least one rigid material 125 can be filled with one or more soft materials to generate a 2D blank 120 having variable stiffness. As used herein, “soft” materials may be or may include any material with a modulus from about 1 MPa to about 500 MPa, including, but not limited to, a thermoplastic polyurethane (“TPU”) elastomer, a polyester elastomer, a polyolefin elastomer, a styrenic elastomer, an acrylic elastomer, an ethylene vinyl acetate, a polyamide elastomer, or other types of elastomeric materials. In other words, the stiffness of the rigid material may be higher than the stiffness of the soft material. The rigid material and soft material may have a plurality of additional and/or alternative variable mechanical properties. For example, in some embodiments, a melting temperature threshold of the rigid material may be higher than a melting temperature threshold of the soft material. As another example, in some embodiments, the rigid material may have a higher hardness than the soft material.

The process 100 may include forming a 3D dental aligner 140 from the 2D blank 120. For example, the 2D blank 120 may be thermoformed (e.g., by the thermoforming system described herein) using the dental dentition mold 135 to form the 3D dental aligner 140 corresponding to a generated treatment plan for a patient. The 3D dental aligner 140 may include at least one rigid region 145 and at least one soft region 150 corresponding to the modeled rigid material regions 115 and the modeled soft material regions 110 of the digital model 105. The rigid regions 145 may correspond to portion of the rigid material 125 and the soft regions 150 may correspond to the discontinuities 130 formed within the rigid material 125 that have been filled with one or more soft materials. In some embodiments, the dental aligner 140 may be mapped relative to the digital model 105 to determine whether the soft regions 150 of the dental aligner 140 accurately match the modeled soft material regions 110 of the digital model 105. For example, a projection of the digital model 105 may be overlaid onto the fabricated dental aligner 140 such that a distance between the modeled soft material regions 110 of the digital model 105 and the soft regions 150 of the fabricated dental aligner 140 can be determined. If the distance measured is greater than a predetermined threshold, the aligner 140 may be discarded or refabricated.

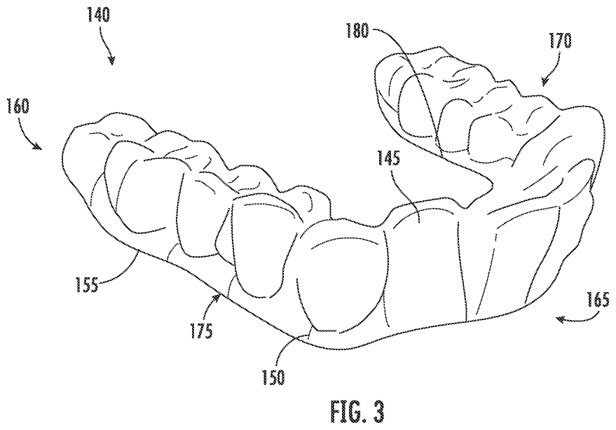

FIG. 3 depicts an example 3D dental aligner 140 formed from a 2D blank 120, according to an exemplary embodiment. Referring to FIG. 3, the 3D dental aligner 140 may include an exterior edge 155 that may be positioned proximate an external gingiva line of a patient such that the exterior edge 155 may interface with a patient's gums (e.g., as determined by the treatment planning computer system 15). The 3D dental aligner 140 may include an interior edge 180 that may be positioned proximate a patient's tongue. The 3D dental aligner 140 may include a rear end 160 that may be positioned proximate a rear of a patient's mouth (e.g., closest to molar teeth of a patient) and a front end 165 that may be positioned proximate a front of a patient's mouth (e.g., closest to front teeth of the patient). The 3D dental aligner 140 may include a top side 175 that may include the edge 155 and a bottom side 170 that may include one or more surfaces that receive a patient's tooth. The 3D dental aligner 140 shown in FIG. 3 may correspond to a dental aligner for an upper dental arch of a patient (e.g., for a patient's upper teeth). A dental aligner 140 for a lower dental arch of a patient may include one or more similarities or differences (e.g., the top side 175 and the bottom side 170 may be opposite).

In some embodiments, the soft regions 150 may be located at or near the exterior edge 155 and/or the interior edge 180. For example, the soft regions 150 may extend at least longitudinally between the interior edge 180 and the exterior edge 155, as depicted in FIG. 3. In some embodiments, the soft regions 150 may be located in between the regions of the dental aligner 140 that receive and interface with one or more teeth (e.g., segmented between the interproximal region of the teeth). For example, the rigid regions 145 may receive and/or interface with the teeth and the soft regions 150 may allow for more elasticity than the rigid regions 145 such that the rigid regions 145 can be pulled, pushed, deformed, or manipulated to comfortably fit onto one or more teeth. In some embodiments, the soft regions 150 may extend at least partially laterally along one or more surfaces of the dental aligner 140 (e.g., on the surface that interfaces with the teeth, on the opposing surface that does not interface with the teeth, on another surface, or any combination thereof). For example, at least one soft region 150 may extend between two or more teeth to facilitate enhancing control of force exerted on the two or more teeth. The soft regions 150 (e.g., the discontinuities of the rigid regions 145) may include any shape, size, or configuration. For example, the magnitude, direction, and/or trajectory of the forces applied to one or more teeth can be at least partially controlled by the shape, size, and configuration of the discontinuity having the soft material. In other words, the dimensions (e.g., length, width, depth, etc.) and/or the geometry of the discontinuity can be calculated, or otherwise determined, to reflect a specific elasticity (e.g., ability to deform, move, flex, etc.) within an area of the rigid regions 145. In some embodiments, the soft regions 150 can be configured as biasing members within the discontinuities of the rigid regions 145. For example, a discontinuity can be sized such that the discontinuity (e.g., a soft region 150) is stretched when the aligner 140 receives the one or more teeth of the patient and the soft material within the discontinuity may pull the rigid regions 145 surrounding the discontinuity in one or more directions (e.g., to compress one or more teeth). As another example, the discontinuity may be sized and/or shaped such that a soft region 150 may apply tension to one or more teeth.

The aligner 140 may include any number of discontinuities and/or soft regions 150. For example, the aligner 140 can include zero soft regions 150. The aligner 140 can include one or more soft regions 150. The aligner 140 can include a plurality of soft regions 150 each positioned symmetrically about the aligner 140, or each independent of one another relative to the aligner 140 (e.g., asymmetric soft regions 150 and/or mismatched soft regions 150). The discontinuities and soft regions 150 of the dental aligner 140 can facilitate moving one or more teeth, decreasing or increasing proximal space between one or more teeth, rotating one or more teeth, or other various movements of teeth in accordance with the generated treatment plan.

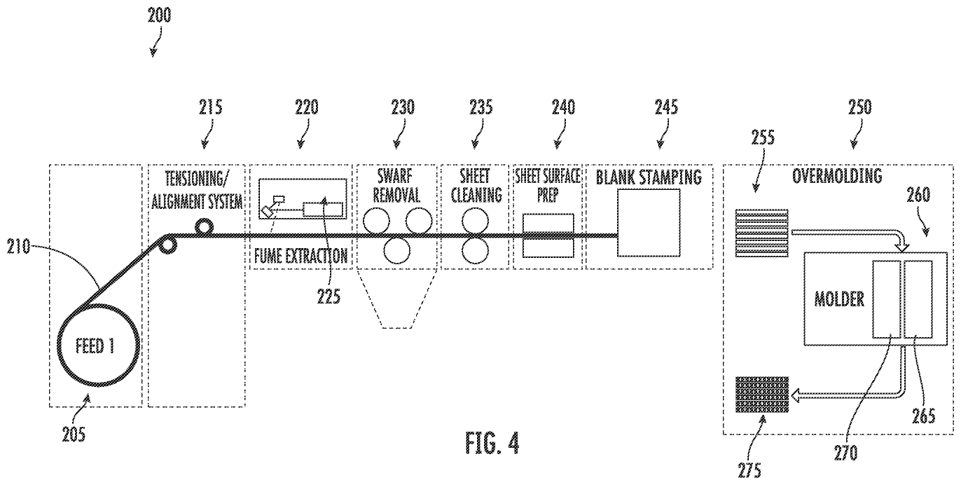

FIG. 4 depicts an example flow chart of a first process 200 of generating a 2D blank having variable stiffness through one or more systems and apparatuses (e.g., via overmolding), according to an exemplary embodiment. The generated 2D blanks described herein may be similar in configuration to the 2D blank 120 shown and described in FIG. 2. The process 200 may begin by receiving a continuous sheet (e.g., in roll form) of first material 210 from a feed 205 of the first material 210. The process 200 may include feeding the first material 210 through a tensioning or alignment system during a tensioning process 215 where the sheet of first material 210 is tensioned such that at least a portion of the sheet of the first material 210 is pulled, stretched, or laid flat. For example, the tensioning or alignment system may include one or more rollers that may apply tension to the sheet of first material 210. The process 200 may include feeding the first material 210 through a cutting process 220 by a cutting apparatus 225. For example, the cutting apparatus 225 may include, but is not limited to, a laser cutting device, a CNC cutting device (e.g., cutter or mill), an etching device, a blade, a photo polymer, a die cutter, or another type of cutting device that can cut one or more discontinuities into at least a portion of the first material 210. As described herein, the discontinuities can vary in shape, size, and/or configuration. In some embodiments, the cutting process 220 may include one or more fume extractors to facilitate reducing fumes that occur as a result of cutting the discontinuities into the first material 210.

The process 200 may include removing debris by a swarf removal process 230 in which one or more swarf removing apparatuses remove excess debris caused by cutting the discontinuities into the sheet of first material during the cutting process 220. The swarf removal process 230 may include one or more swarf removal systems (SRS) or swarf removal tools to remove the debris. For example, the swarf removal process 230 may include one or more hand tools, automated machines, shredders, waste containers, and/or other apparatuses that may facilitate in removal of debris. The process 200 may include cleaning the first material 210 by a sheet cleaning process 235. For example, the sheet cleaning process 235 may include one or more sheet cleaning apparatuses or systems that facilitate removing or reducing dust, dirt, debris, fluids, or other surface contaminants from the sheet of first material 210.

The process 200 may include preparing the first material 210 by a sheet surface preparation process 240. For example, the sheet surface preparation process 240 may include one or more systems or apparatuses that facilitate removing one or more impurities from the surface of the sheet of first material 210, providing a coating of material onto the surface of the sheet of first material 210, or another form of preparing the sheet of first material 210 for stamping, molding, and/or various other post-cutting processes. The process 200 may include stamping a 2D blank from the sheet of first material 210 by a blank stamping process 245. For example, the blank stamping process 245 may include cutting out the 2D blank from a sheet of first material by one or more stamping apparatuses (e.g., die cutters, stamping presses, etc.).

The process 200 may include integrally forming a second material within the formed discontinuities of the first material 210 of the 2D blank by one or more molding processes 250. For example, a molding apparatus 260 (e.g., an overmolding apparatus, an insert molding apparatus, or another type of molding apparatus) may be configured to mold at least one 2D blank 255 having the first material 210 with at least one discontinuity (e.g., the substrate) by clamping the 2D blank 255 between a first mold plate 265 and a second mold plate 270 having one or more injection channels such that the second material (e.g., the overmolding material) is injected and molded within the discontinuities of the first material 210 to form a 2D blank 275 having the first material 210 and the second material integrally formed within the discontinuities of the first material 210. The molding process 250 may integrally form the second material within the discontinuities of the first material 210 such that the second material is fixed relative to the first material 210 and fills the entire discontinuity. For example, the second material can be or can include one or more soft materials and the first material 210 can be or can include one or more rigid materials. The molding apparatus 260 may be configured to inject the soft material (e.g., the second material) at a temperature at which the second material melts, but the rigid material (e.g., the first material 210) does not such that the second material at least partially reaches a molten form to completely fill at least one discontinuity of the first material 210 while the first material 210 remains at least partially in a solid state. By way of example, if the first material 210 is a co-polyester and the second material is TPU, temperature applied to the materials may be in the range of 150° C.-450° C. This example is for illustrative purposes only. It should be understood that the temperature may vary depending on the types of materials. When the 2D blank returns to a temperature at which the second material is no longer in a molten state, the second material is integrally formed within the discontinuity such that even if the first material bends or flexes, the second material remains conformed to the entire discontinuity. The overmolded 2D blank 275 may be or may include a multi-material nonhomogeneous blank that can be used for thermoforming to fabricate a 3D aligner as described herein. In some embodiments, the formed 2D blank 275 is single-ply (e.g., one layer) of at least two materials. In some embodiments, the formed 2D blank 275 includes several layers each including multiple materials.

Molding the second material with the first material 210 in accordance with the process 200 may have numerous advantages over other techniques. For example, the molding process 250 may include molding the second material with the first material at a high-temperature (e.g., between 125° C. and 450° C.) by a high-pressure injection (e.g., between 125 and 200 MPa), which may allow for superior bonding between the first material 210 and the second material. Additionally, mold clamping may facilitate preventing the first material 210 (e.g., rigid material) from deforming significantly (e.g., such that the formed 2D blank 275 cannot be used to form a 3D dental aligner) during soft material injection and may facilitate a more continuous interface between the first material 210 and the second material within the discontinuities than other processes. Further, overmolding may facilitate enabling the placement of the soft material within the discontinuities of the rigid material without having to cover the entire 2D blank with the soft material.

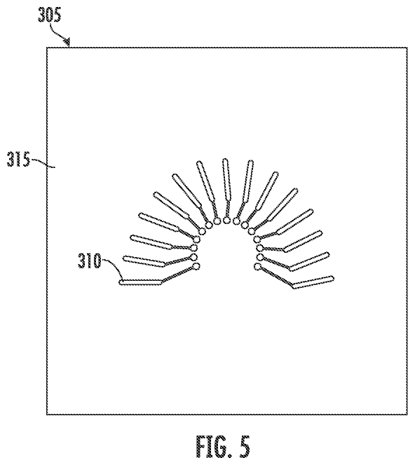

FIG. 5 depicts an example of a 2D blank 305 having a first material 315 (e.g., a rigid material) and a second material 310 (e.g., a soft material) integrally formed within a plurality of discontinuities within the first material 315. The 2D blank 305 may correspond to the molded 2D blank 275 formed by the first process 200. The 2D blank 305 may correspond to a generated 2D blank formed by one or more of the other various processes described herein. In some embodiments, the 2D blank 305 may be approximately 110 mm tall, 110 mm wide, and 0.5 mm thick. In some embodiments, the 2D blank 305 may be larger or smaller in size. Referring to FIG. 5, the second material 310 may completely fill at least one discontinuity within the first material 315 such that the second material 310 completely fills in areas of the first material 315 left open by a cutting process (e.g., the cutting process 220). The stiffness of the first material 315 may be greater than the stiffness of the second material 310. For example, in some embodiments, the first material 315 is a rigid substrate, such as a co-polyester or a similar material and the second material 310 is an elastomer material such as TPU elastomer. In some embodiments, one or more of the discontinuities within the first material 315 may be at least partially connected such that one portion of the discontinuity may form a channel for another discontinuity (e.g., such that a single injection channel can supply molten second material to a plurality of discontinuities through the channel). In some embodiments, the second material may be injected by a plurality of injection channels.

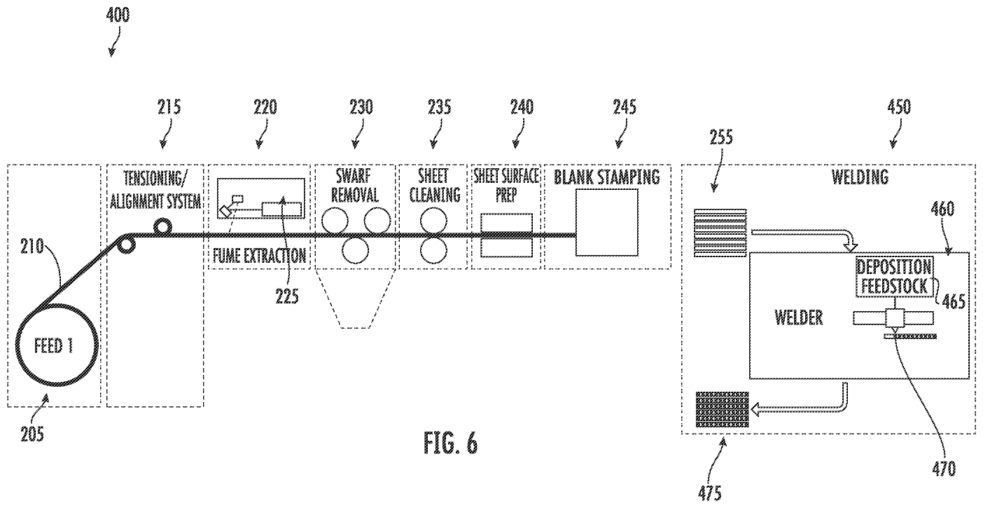

FIG. 6 depicts an example flow chart of a second process 400 of generating a 2D blank having variable stiffness through one or more systems and apparatuses (e.g., via welding), according to an exemplary embodiment. The process 400 may include at least some of the same processes or apparatuses described with reference to the process 200 shown in FIG. 4. For example, the process 400 may include feeding a sheet of first material 210 into a tensioning or alignment system during a tensioning process 215, feeding the first material 210 into a cutting process 220, feeding the first material 210 into a swarf removal process 230, feeding the first material 210 into a sheet cleaning process 235, feeding the first material 210 into a sheet surface preparation process 240, and/or feeding the first material 210 into a blank stamping process 245. The second process 400 may differ from the first process 200 in one or more ways. For example, the second process 400 may include a welding process 450 to integrally form second material with the first material 210 (e.g., as an alternative to using a molding process 250). For example, a welding apparatus 460 may be configured to weld and/or fill (e.g., by melting, bonding, and/or by one or more adhesives) the second material 470 (e.g., soft material from second material deposit feedstock 465) into the discontinuities of the first material 210 of one or more stamped 2D blanks 255 to form a welded 2D blank 475 having the second material 470 integrally formed within the discontinuities of the first material 210. The formed 2D blank 475 may be or may include multiple layers of one or more materials. The welding apparatus 460 may be configured to heat the materials to a temperature at which the first material 210 does not melt, but the second material does. By way of example, if the first material 210 is a co-polyester and the second material is TPU, temperature applied to the materials may be in the range of 150° C.-450° C. This example is for illustrative purposes only. It should be understood that the temperature may vary depending on the types of materials.

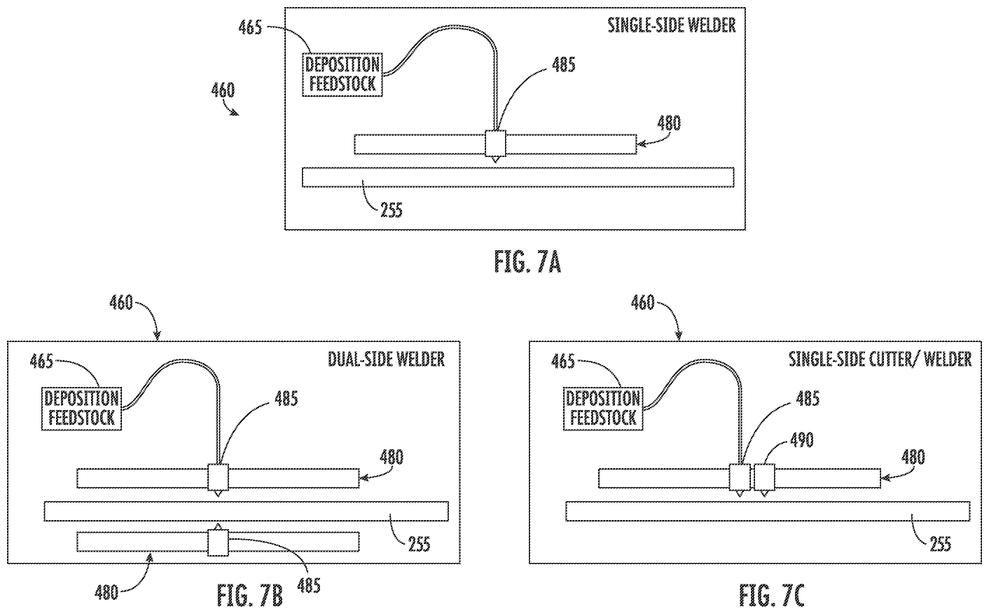

FIGS. 7A-7C depict various examples of welding apparatuses 460 that may be configured to weld the second material within the discontinuities of the first material 210. Referring to FIG. 7A, the welding apparatus 460 may include a single-side welding system (e.g., CNC welder or another system). For example, the welding apparatus 460 may include feedstock 465 of the second material that supplies feed of the second material to at least one depositing apparatus 485 (e.g., an extruder head, a nozzle, or another apparatus that can deposit the second material) that operably couples to a first motion system 480. The first motion system 480 may include one or more controllers operably coupled to a robotic motion system to move the depositing apparatus 485 in at least one direction to melt and deposit (e.g., extrude) the second material into the discontinuities of the first material 210 of one or more stamped 2D blanks 255. The welding apparatus 460 may be configured to integrally form the second material deposited into the discontinuities by melting, bonding, and/or by one or more adhesives (e.g., using heat, pressure, ultrasonic vibration, and/or mechanical interlocking).

Referring to FIG. 7B, the welding apparatus 460 may include a dual-side welding system (e.g., CNC welder or another system). For example, the welding apparatus 460 may include feedstock 465 of the second material that supplies feed of the second material to at least two depositing apparatuses 485 (e.g., an extruder head, a nozzle, or another apparatus that can deposit the second material). A first depositing apparatus 485 may operably couple to a first motion system 480 and a second depositing apparatus 485 may operably couple to a second motion system 480. The motion systems 480 may each include one or more controllers operably coupled to a robotic motion system to move the depositing apparatuses 485 in at least one direction to melt and deposit (e.g., extrude) the second material into the discontinuities of the first material 210 of one or more stamped 2D blanks 255. The motions systems 480 may be configured to move each depositing apparatus 485 in the same direction (e.g., such that the depositing apparatuses 485 move simultaneously) or in different directions (e.g., such that the depositing apparatuses 485 move independently). The welding apparatus 460 may be configured to integrally form the second material deposited into the discontinuities by melting, bonding, and/or by one or more adhesives (e.g., using heat, pressure, ultrasonic vibration, and/or mechanical interlocking).

Referring to FIG. 7C, the welding apparatus 460 may include a single-side welding system and cutting system (e.g., CNC welder or another system). For example, the welding apparatus 460 may include feedstock 465 of the second material that supplies feed of the second material to at least one depositing apparatus 485 (e.g., an extruder head, a nozzle, or another apparatus that can deposit the second material) that operably couples to a first motion system 480. The first motion system 480 may include one or more controllers operably coupled to a robotic motion system to move the depositing apparatus 485 in at least one direction to melt and deposit (e.g., extrude) the second material into the discontinuities of the first material 210. The welding apparatus 460 may include at least one cutting apparatus 490 (e.g., a laser, a CNC cutting device, etc.) operably coupled to the first motion system 480. The first motion system 480 may be configured to move the cutting apparatus 490 to cut one or more portions of the first material 210 or the second material. The first motion system 480 may be configured to move the cutting apparatus 490 and the depositing apparatus 485 simultaneously or separately. The welding apparatus 460 may be configured to integrally form the second material deposited into the discontinuities of one or more stamped 2D blanks 255 by melting, bonding, and/or by one or more adhesives (e.g., using heat, pressure, ultrasonic vibration, and/or mechanical interlocking). In some embodiments, the welding apparatus 460 may replace and/or supplement the cutting process 220.

Welding the second material with the discontinuities of the first material 210 may have numerous advantages over other processes. For example, the depositing apparatus 485 may include a high-temperature nozzle (e.g., 125° C.-450° C.), which can allow superior bonding between the first material 210 and the second material as compared to other processes. Additionally, the welding process 450 may allow variable thickness of the formed 2D blank 475 (e.g., the 2D blank includes a larger thickness of a portion of the first material 210, a portion of the second material, or a combination thereof in comparison to another portion of the 2D blank), which can allow for better control of the geometry of the 2D blank and the 3D dental aligner and for the second material to better encapsulate the discontinuities in the first material 210. Further, welding may facilitate a more continuous interface between the first material 210 and the second material within the discontinuities than other processes.

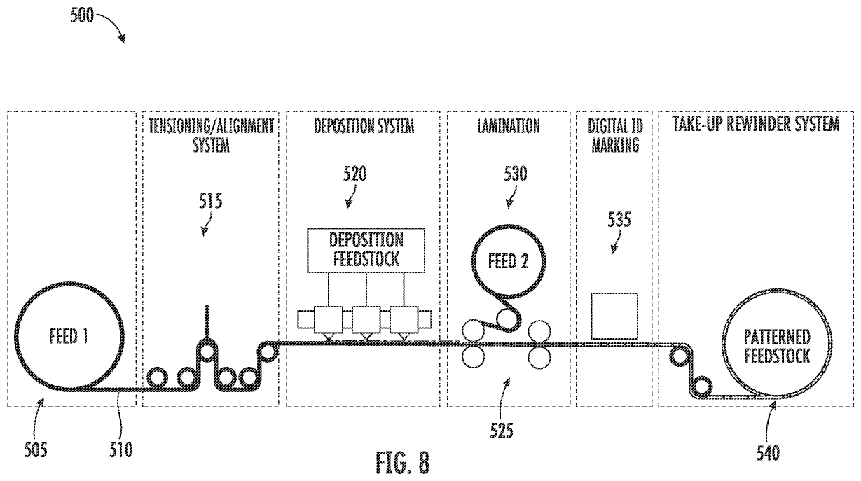

FIG. 8 depicts a third process 500 of generating a 2D blank having variable stiffness through one or more systems and apparatuses (e.g., via deposition structured laminating), according to an exemplary embodiment. The process 500 may begin by receiving a second material 510 from a feedstock 505 of second material 510. The second material 510 may include one or more soft materials described herein (e.g., elastomers such as TPU, polymers, etc.) The process 500 may include feeding a sheet of the second material 510 through a tensioning or alignment system during a tensioning process 515. The tensioning process 515 may be similar to the tensioning process 215 described with reference to FIGS. 4 and 6. For example, the tensioning or alignment system may include one or more rollers. The process 500 may include depositing first material (e.g., one or more rigid materials described herein, such as a co-polyester) onto the sheet of second material 510 during a deposition process 520 (e.g., local heating process in extrusion). The deposition process 520 may include one or more feeds of the first material that provide first material to one or more depositing apparatuses (e.g., FDM, piezo jet, extruding heads, or nozzles) that are operably coupled to one or more robotic motion systems that can move the depositing apparatuses in at least one direction. The depositing apparatuses can deposit first material onto predetermined regions of the second material 510 such that the first material includes one or more discontinuities, as shown in FIG. 8. In some embodiments, the deposition process 520 may include one or more additive processes (e.g., 3D printing, xerography, screen printing, etc.) to deposit the first material onto a portion of the second material 510. The process 500 may include laminating a second feed 530 of the second material 510 onto the sheet of second material 510 having the deposited first material during a lamination process 525 (e.g., by a lamination apparatus or system) such that the first material is laminated between a first layer of the second material 510 and a second layer of the second material 510 to integrally form the softer second material 510 within one or more discontinuities of the rigid first material. The second feed 530 of the second material 510 may be in filament, pellet, liquid, and/or powder form. The lamination process 525 can fill any micro-porosity of the first material.

The process 500 may include marking the laminated first material and second material 510 by a digital ID marking process 535. For example, the digital ID marking process 535 may include one or more inkjets or lasers configured to etch or deposit one or more markings (e.g., an identification number, image, barcode, QR code, etc.) onto the laminated sheets of material (e.g., a portion of the first material, second material, or a combination thereof) such that the laminated sheets can be processed by the digital marking. The process 500 may include feeding the laminated material into a rewinder process 540. For example, the rewinder processes 540 may include one or more take-up rewinder systems that can wind the laminated sheets of material into a feedstock that can be used to form one or more 2D blanks having variable stiffness (e.g., the patterned feedstock can be removed and used in a traditional aligner thermoforming process).

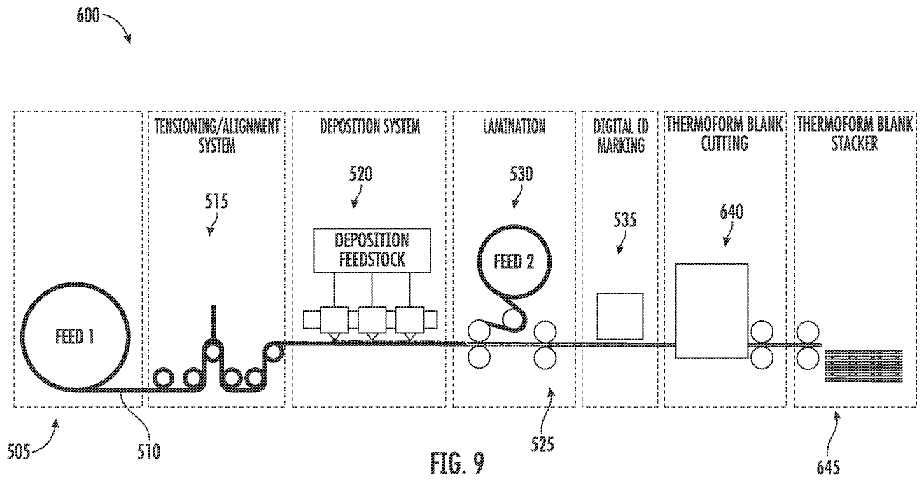

FIG. 9 depicts a fourth process 600 of generating a 2D blank having variable stiffness through one or more systems and apparatuses (e.g., via deposition structured laminating), according to an exemplary embodiment. The fourth process 600 may include at least some of the same processes described with reference to the third process 500 shown in FIG. 8. For example, the process 600 may include receiving the second material 510 from at least one feedstock 505 of second material 510. The process 600 may include feeding a sheet of the second material 510 through a tensioning or alignment system during a tensioning process 515. The process 600 may include depositing first material (e.g., one or more rigid materials described herein such as a co-polyester) onto the sheet of second material 510 during a deposition process 520. The depositing apparatuses can deposit first material onto predetermined regions of the second material 510 such that the first material includes one or more discontinuities. The process 600 may include laminating a second feed 530 of the second material 510 onto the sheet of second material 510 having the deposited first material during a lamination process 525 such that the first material is laminated between a first layer of the second material 510 and a second layer of the second material 510 to integrally form the softer second material 510 within one or more discontinuities of the more rigid first material. The process 600 may include marking the laminated first material and second material 510 by a digital ID marking process 535.

The process 600 may include cutting a 2D blank from the laminated material by a blank cutting process 640 using one or more die cutters or stamping apparatuses. The blank cutting process 640 may be similar in some regards to the blank stamping process 245 described with reference to FIGS. 4 and 6. The blank cutting process 640 may include one or more rollers to distribute the cut 2D blanks formed from the laminated material to a blank stacking process 645 in which the cut 2D blanks are stacked on top of one another (e.g., as opposed to using a rewinder system). Cutting and stacking each 2D blank may reduce damage caused to the feedstock during rewinding.

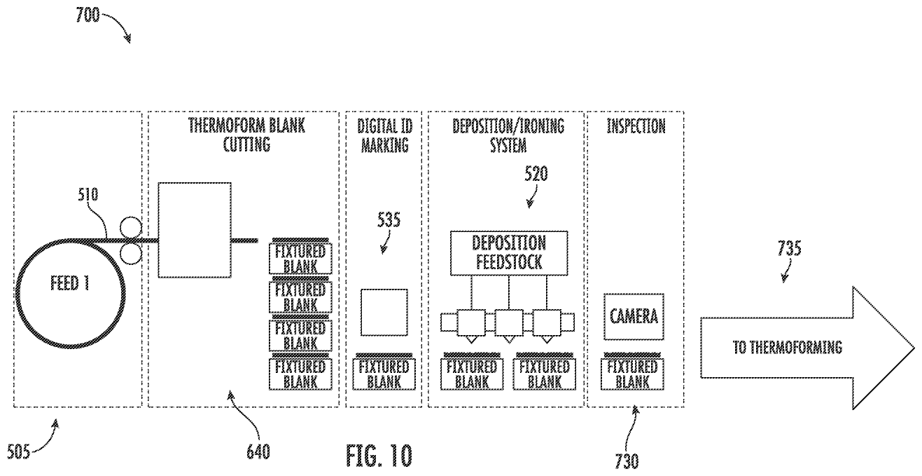

FIG. 10 depicts a fifth process 700 of generating a 2D blank having variable stiffness through one or more systems and apparatuses (e.g., via deposition structured laminating), according to an exemplary embodiment. The fifth process 700 may include at least some of the same processes described with reference to the third process 500 or fourth process 600 shown in FIGS. 8 and 9. For example, the process 700 may include receiving the second material 510 from at least one feedstock 505 of second material 510. The process 700 may include cutting a 2D blank from the second material 510 by a blank cutting process 640 using one or more die cutters or other stamping apparatuses. The blank cutting process 640 may be similar in some regards to the blank stamping process 245 described with reference to FIGS. 4 and 6. The blank cutting process 640 may include one or more components configured to distribute the cut 2D blanks formed from the second material 510 to corresponding fixtures to separate each cut blank. The process 700 may include marking the cut second material 510 by a digital ID marking process 535. The process 700 may include depositing first material (e.g., one or more rigid materials described herein such as a co-polyester) onto the sheet of second material 510 during a deposition process 520. The depositing apparatuses can deposit first material onto predetermined regions of the second material 510 such that the first material includes one or more discontinuities. The process 700 may include inspecting the blank having first material deposited onto cut second material 510 during an inspection process 730. For example, the inspection process 730 may include inspecting image data or video data of each cut 2D blank using an imaging device. The process 700 may include feeding the cut 2D blanks having first material deposited onto the second material 510 and placed onto a fixture to be thermoformed to integrally form the patterned first material with the second material at a thermoforming process 735.

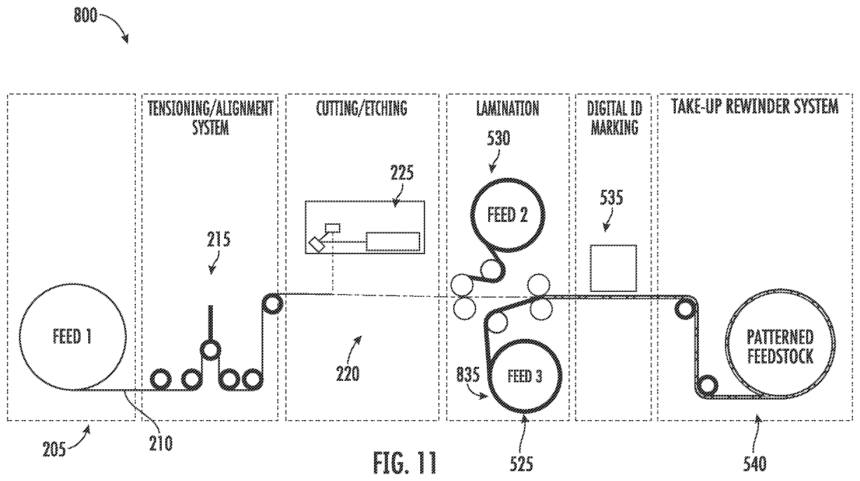

FIG. 11 depicts a sixth process 800 of generating a 2D blank having variable stiffness through one or more systems and apparatuses (e.g., via laser structured laminating), according to an exemplary embodiment. The sixth process 800 may include at least some of the same processes described with reference to the first process 200, the second process 400, the third process 500, the fourth process 600, or the fifth process 700 as shown in FIGS. 4 and 6-10. For example, the process 800 may include receiving first material 210 (e.g., one or more rigid materials described herein, such as a co-polyester) from at least one feedstock 205 of first material 210. The process 800 may include feeding the first material 210 through a tensioning or alignment system during a tensioning process 215 where the sheet of first material 210 is tensioned such that at least a portion of the sheet of the first material 210 is flat. The process 800 may include feeding the sheet of first material 210 through a cutting process 220 by a cutting apparatus 225. For example, the cutting apparatus 225 may be configured to cut one or more discontinuities into the first material 210.

The process 800 may include laminating a second feed 530 of second material (e.g., one or more soft materials) onto the sheet of first material 210 during a lamination process 525. The lamination process 525 may further include laminating a third feed 835 of the second material such that the first material 210 is laminated between a first layer of the second material and a second layer of the second material to integrally form the softer second material within one or more discontinuities of the more rigid first material 210. The second feed 530 and/or the third feed 835 of the second material may be in filament, pellet, liquid, and/or powder form. The lamination process 525 can fill any micro-porosity of the first material. The process 800 may include marking the laminated first material 210 and second material by a digital ID marking process 535. The process 800 may include feeding the laminated material into a rewinder process 540. For example, the rewinder processes 540 may include one or more take-up rewinder systems that can wind the laminated sheets of material into a feedstock that can be used to form one or more 2D blanks having variable stiffness (e.g., the patterned feedstock can be removed and used in a traditional aligner thermoforming process).

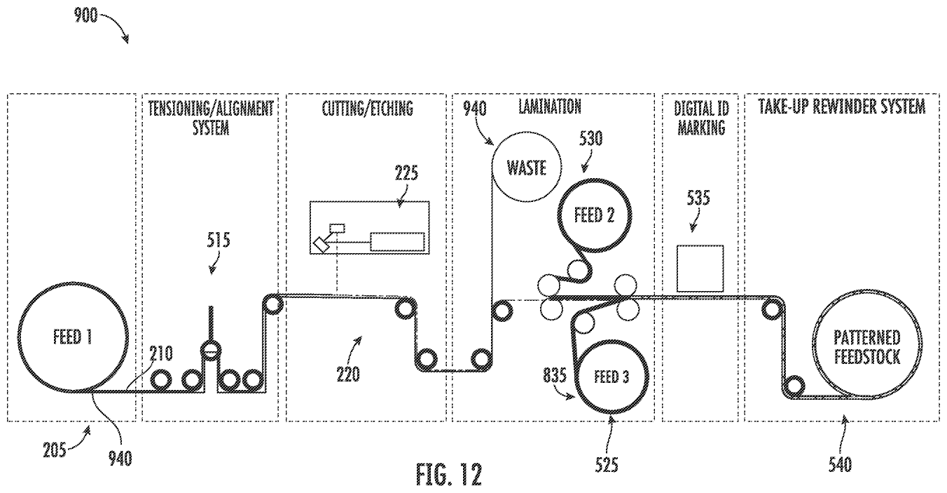

FIG. 12 depicts a seventh process 900 of generating a 2D blank having variable stiffness through one or more systems and apparatuses (e.g., via laser structured laminating), according to an exemplary embodiment. The seventh process 900 may include at least some of the same processes described with reference to the first process 200, the second process 400, the third process 500, the fourth process 600, the fifth process 700, or the sixth process as shown in FIGS. 4 and 6-11. For example, the process 900 may include receiving first material 210 (e.g., one or more rigid materials described herein, such as a co-polyester) from at least one feedstock 205 of first material 210. The first feedstock 205 of material in this process 900 may include a flexible material (such as a polyethylene film, a siliconized paper, etc.) coupled to a portion of the first material 210 (e.g., as a flexible backing 940). The process 900 may include feeding the first material 210 with the flexible backing 940 through a tensioning or alignment system during a tensioning process 515 where the sheet of first material 210 is tensioned such that at least a portion of the sheet of the first material 210 is pulled or stretched. The process 900 may include feeding the sheet of first material 210 with the flexible backing 940 through a cutting process 220 by a cutting apparatus 225. For example, the cutting apparatus 225 may be configured to cut one or more discontinuities into the first material 210. The flexible backing 940 may facilitate preventing a portion of the cutting apparatus from extending beyond the first material 210 (e.g., prevent laser exit burning). Further, the flexible backing 940 may facilitate minimizing damage and/or stretching to the first material 210 during the cutting process 220.

The process 900 may include laminating a second feed 530 of second material (e.g., one or more soft materials) onto the sheet of first material 210 during a lamination process 525. The lamination process 525 may further include laminating a third feed 835 of the second material such that the first material 210 is laminated between a first layer of the second material and a second layer of the second material to integrally form the softer second material within one or more discontinuities of the more rigid first material 210. The lamination process 525 may further include removing the flexible backing 940 as waste. The second feed 530 and/or the third feed 835 of the second material may be in filament, pellet, liquid, and/or powder form. The lamination process 525 can fill any micro-porosity of the first material. The process 900 may include marking the laminated first material 210 and second material by a digital ID marking process 535. The process 900 may include feeding the laminated material into a rewinder process 540. For example, the rewinder processes 540 may include one or more take-up rewinder systems that can wind the laminated sheets of material into a feedstock that can be used to form one or more 2D blanks having variable stiffness (e.g., the patterned feedstock can be removed and used in a traditional aligner thermoforming process).

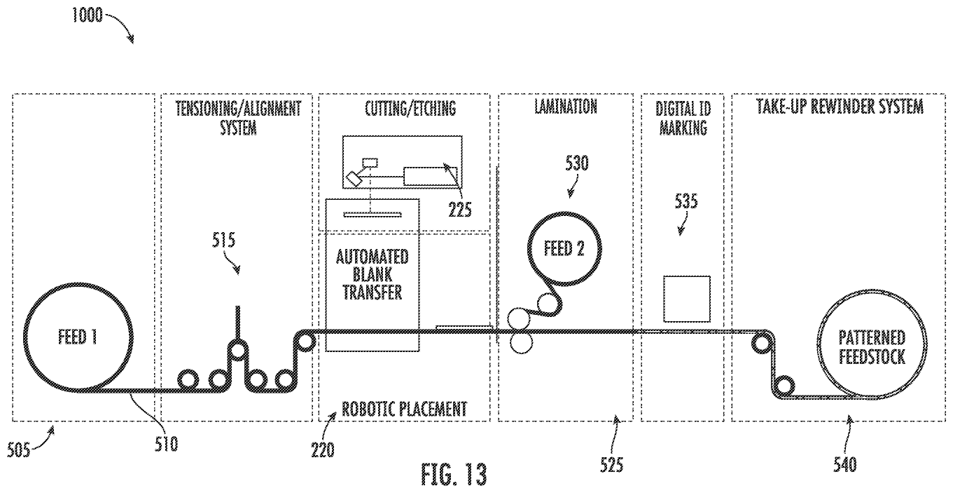

FIG. 13 depicts an eighth process 1000 of generating a 2D blank having variable stiffness through one or more systems and apparatuses (e.g., via laser structured laminating), according to an exemplary embodiment. The eighth process 1000 may include at least some of the same processes described with reference to the first process 200, the second process 400, the third process 500, the fourth process 600, the fifth process 700, the sixth, or the seventh process as shown in FIGS. 4 and 6-12. For example, the process 1000 may begin by receiving a second material 510 from a feedstock 505 of second material 510. The second material 510 may include one or more soft materials described herein (e.g., elastomers such as TPU, polymers, etc.) The process 1000 may include feeding a sheet of the second material 510 through a tensioning or alignment system during a tensioning process 515. The process 1000 may include depositing first material (e.g., one or more rigid materials described herein such as a co-polyester) onto the sheet of second material 510 during a cutting process 220. The cutting process 220 may include cutting (e.g., by a cutting apparatus 225) one or more feeds of the first material intermittently such that the cut regions of first material are deposited onto the second material 510 in a pattern, as shown in FIG. 13. For example, the cutting apparatus 225 can cut the first material and deposit the first material while the second material 510 moves continuously such that the first material deposits onto predetermined regions of the second material 510 to form one or more discontinuities. The process 1000 may include laminating a second feed 530 of the second material 510 onto the sheet of second material 510 having the deposited first material during a lamination process 525 such that the first material is laminated between a first layer of the second material 510 and a second layer of the second material 510 to integrally form the softer second material 510 within one or more discontinuities of the more rigid first material. The second feed 530 of the second material 510 may be in filament, pellet, liquid, and/or powder form. The lamination process 525 can fill any micro-porosity of the first material.

The process 1000 may include marking the laminated first material and second material 510 by a digital ID marking process 535. For example, the digital ID marking process 535 may include one or more inkjets or lasers configured to etch or deposit one or more markings (e.g., an identification number, image, barcode, QR code, etc.) onto the laminated sheets of material such that the laminated sheets can be processed by the digital marking. The process 1000 may include feeding the laminated material into a rewinder process 540. For example, the rewinder processes 540 may include one or more take-up rewinder systems that can wind the laminated sheets of material into a feedstock that can be used to form one or more 2D blanks having variable stiffness (e.g., the patterned feedstock can be removed and used in a traditional aligner thermoforming process).

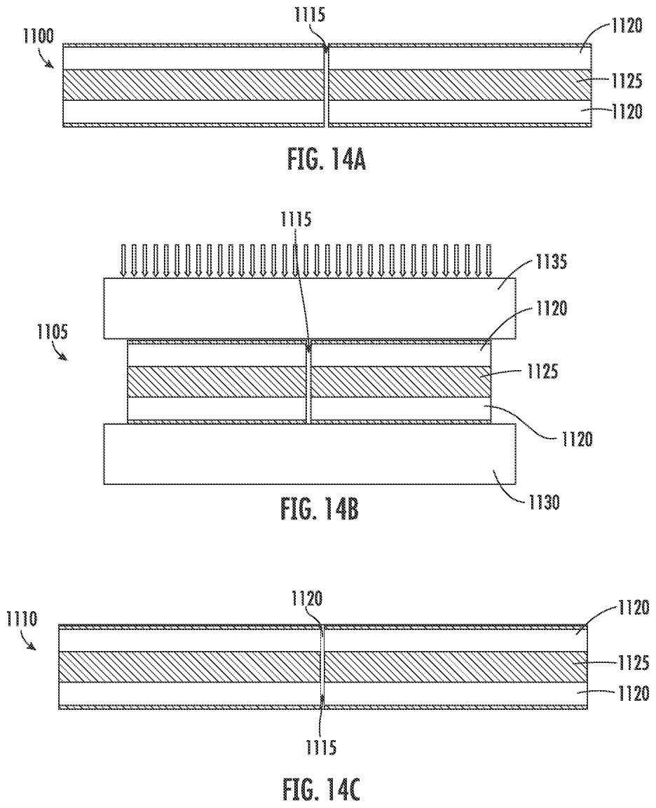

FIGS. 14A-14C depict example schematics of steps to form a 2D blank having variable stiffness, according to an exemplary embodiment. The steps described herein may be performed with a cut 2D blank or with one or more rolls of material. The steps may be implemented into one or more of the processes 200, 400, 500, 600, 700, 800, 900, 1000 described herein. Referring to FIG. 14A, at step 1100, a cutting apparatus may form at least one discontinuity 1115 in at least a portion of first material 1125 (e.g., one or more rigid materials described herein) and in at least a portion of second material 1120 (e.g., one or more soft materials described herein). For example, the discontinuity 1115 may include a cut that extends entirely through a supply material having at least one layer of first material 1125 and at least one layer of second material 1120. The discontinuity 1115 may be formed by any of the cutting processes described herein (e.g., laser cutting, etching, CNC cutting, skiving, shaving, etc.). Referring to FIG. 14B, at step 1105, the supply material is positioned between at least one high-temperature mold plate (e.g., first mold plate 1130 and second mold plate 1135) that clamps the materials together. In some embodiments, the materials may be additionally and/or alternatively positioned between two rollers that can apply heat. The mold plates and/or rollers may be configured to apply pressure (e.g., compress) that materials. Referring to FIG. 14C, at step 1110, the heat from the mold plates causes the second material 1120 to melt (e.g., reach a molten state) without causing the first material 1125 to melt (e.g., maintain at least partially in a solid state) such that the second material 1120 seeps into the discontinuity 1115 within the first material 1125 such that the second material 1120 is integrally formed within the entirety of the discontinuity. For example, the mold plates and/or rollers may be configured to heat the materials to a temperature at which the first material 1125 does not melt, but the second material 1120 does. By way of example, if the first material 1125 is a co-polyester and the second material 1120 is TPU, temperature applied to the materials may be in the range of 150° C.-450° C. This example is for illustrative purposes only. It should be understood that the temperature may vary depending on the types of materials. It should further be understood that the positioning of the first material 1125 and the second material 1120 in FIGS. 14A-14C is for illustrative purposes. In some embodiments, the positioning of the first material 1125 and the second material 1120 may differ (e.g., the first material 1125 surrounds one layer of second material 1120).

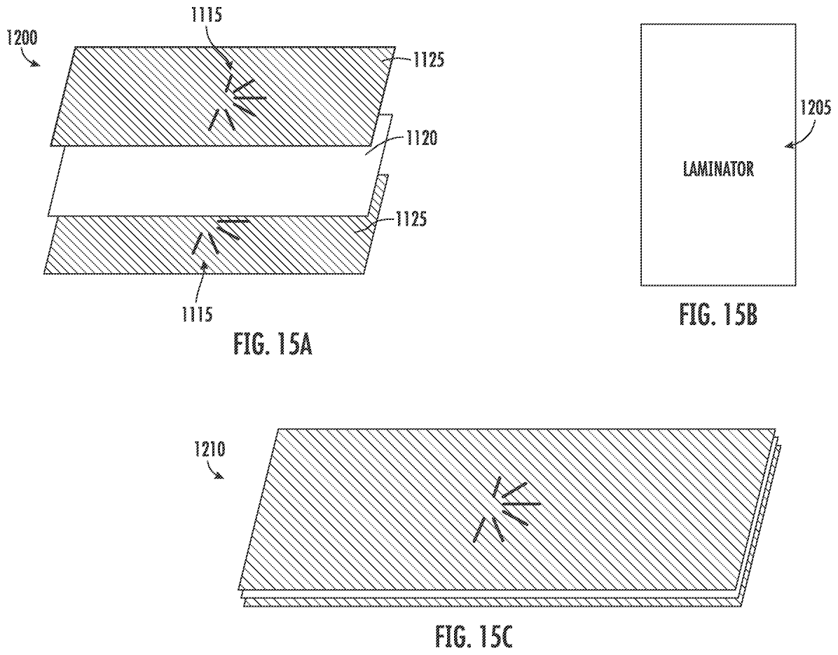

FIGS. 15A-15C depict example schematics of steps to form a 2D blank having variable stiffness, according to an exemplary embodiment. The steps described herein may be performed with a cut 2D blank or with one or more rolls of material. The steps may be implemented into one or more of the processes 200, 400, 500, 600, 700, 800, 900, 1000 described herein. Referring to FIG. 15A, at step 1200, at least one layer of the second material 1120 is positioned between two or more layers of the first material 1125. The layers of first material 1125 may each include one or more discontinuities 1115 formed within the first material 1125. The discontinuities 1115 may extend entirely through the first material 1125, but may not be formed in the second material 1120. Referring to FIG. 15B, at step 1205, the supply material (e.g., the layers of material) may be laminated together by one or more laminating apparatuses. Referring to FIG. 15C, at step 1210, the laminated layers of material may rigidly couple with one another to form one continuous structure in which the second material 1120 is integrally formed within the discontinuities of the first material 1125.

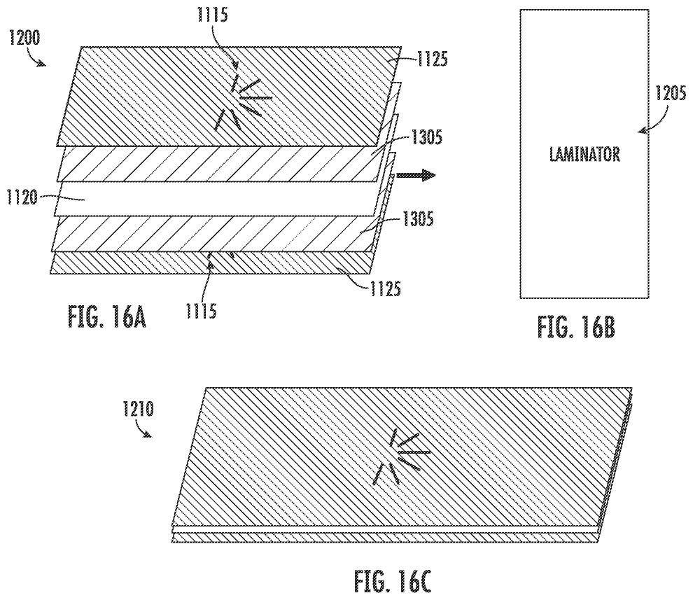

FIGS. 16A-16C depict example schematics of steps to form a 2D blank having variable stiffness, according to an exemplary embodiment. The steps described herein may be performed with a cut 2D blank or with one or more rolls of material. The steps may be implemented into one or more of the processes 200, 400, 500, 600, 700, 800, 900, 1000 described herein. The steps shown in FIGS. 16A-16C may be similar to those shown in FIG. 15A-15C, with an addition of an adhesive material 1305 (e.g., a hot-melt adhesive, a two-part adhesive, a one-part adhesive, an epoxy adhesive, an polyurethane adhesive, a fast-dry adhesive, a cyanoacrylate adhesive, etc.). For example, at step 1200 as shown in FIG. 16A, at least one layer of the second material 1120 is positioned between two or more layers of adhesive material 1305 and two or more layers of the first material 1125. The layers of first material 1125 may each include discontinuities 1115 formed within the first material 1125. The adhesive material 1305 may be coupled with the first material 1125 and/or the second material 1120 via extrusion coating and/or coextrusion. The discontinuities 1115 may extend entirely through the first material 1125, but may not be formed in the second material 1120 or the adhesive material 1305. Referring to FIG. 16B, at step 1205, the layers of material may be laminated together by one or more laminating apparatuses. Referring to FIG. 16C, at step 1210, the laminated layers of material may rigidly couple with one another to form one continuous structure in which the second material 1120 is integrally formed within the discontinuities of the first material 1125.

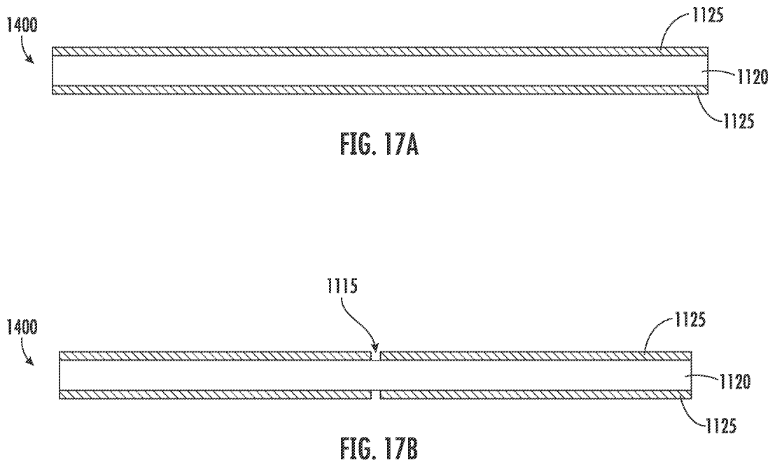

FIGS. 17A-17B depict example schematics of steps to form a 2D blank having variable stiffness, according to an exemplary embodiment. The steps described herein may be performed with a cut 2D blank or with one or more rolls of material. The steps may be implemented into one or more of the processes 200, 400, 500, 600, 700, 800, 900, 1000 described herein. Referring to FIG. 17A, at step 1400, at least one layer of first material 1125 and at least one layer of second material 1120 are coextruded with one another. Referring to FIG. 17B, at step 1405, a cutting apparatus may cut (e.g., laser cutting, etching, CNC cutting, skiving, shaving, etc.) a discontinuity into at least one layer of the first material 1125 (e.g., but not the second material 1120). The coextruded materials may be thermoformed directly to fabricate a dental aligner and/or the coextruded materials may first be laminated prior to thermoforming. In some embodiments, no lamination or pressing is necessary to form the 2D blank.

The one or more processes 200, 400, 500, 600, 700, 800, 900, 1000 can include various additional and/or alternative steps, apparatuses, systems, or other components to form a 3D dental aligner. For example, in some embodiments, the 2D blank with variable stiffness may be formed by one or more casting processes. For example, the one or more discontinuities can be filled with a soft material in the form of a solvent (such as tetrahydrofuran, chloroform, etc.) loaded with thermoplastic elastomer. After the solvent is evaporated, the thermoplastic elastomer can dry into a solid elastomer which can be used to thermoform a 3D dental aligner. For example, the one or more discontinuities can be filled with a casting material such as a UV-cure, heat-cure, or dual-cure resin that will be activated to solidify by the required energy sources, which can be used to thermoform a 3D dental aligner.

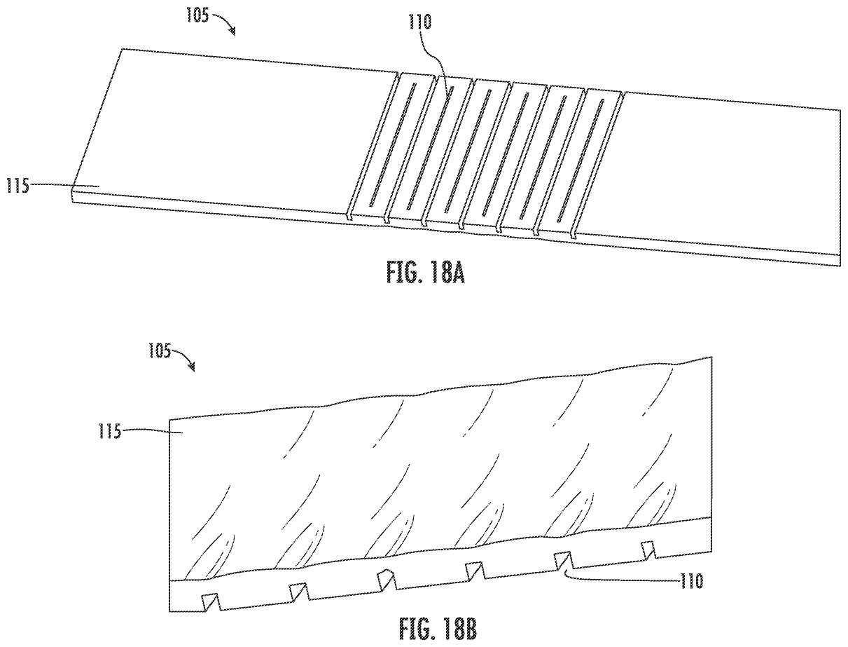

FIGS. 18A and 18B depict example patterns of discontinuities formed in a portion of a digital model 105, according to an exemplary embodiment. For example, FIGS. 18A and 18B illustrate an example model of a pattern of discontinuities to be formed within a portion of rigid material of a dental aligner. Referring to FIGS. 18A and 18B, the pattern may generally include a wave-like pattern. Integrally forming soft material within the wave-like discontinuities may allow the formed 3D dental aligner to be stretched and/or manipulated by the soft material within the discontinuities. It should be understood that the discontinuities may include a variety of additional and/or alternatives shapes, sizes, patterns, and configurations.

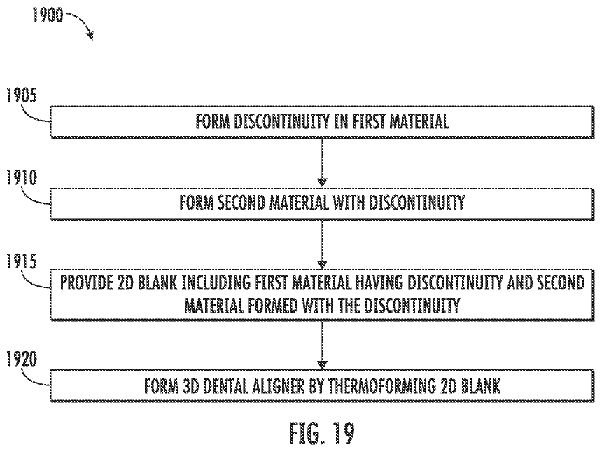

FIG. 19 depicts an illustration of a method 1900 of forming a 3D dental aligner, according to an exemplary embodiment. As an overview, at step 1905, a cutting apparatus and/or a deposition apparatus may form at least one discontinuity in a first material. At step 1910, one or more of a molding apparatus, a welding apparatus, a lamination apparatus, or a coextruder may form a second material within the discontinuity of the first material. At step 1915, one or more of a die cutting apparatus and/or a stamping apparatus may form a 2D blank having the first material and the second material integrally formed within the discontinuity of the first material. At step 1920, a thermoforming apparatus may thermoform the 2D blank using a dental dentition mold to form the 3D dental aligner.

In greater detail, at step 1905, a cutting apparatus and/or a deposition apparatus may form at least one discontinuity in a first material. For example, the first material may be or may include a rigid material described herein. In some embodiments, a cutting apparatus (e.g., a laser, a mill, an etching tool, a blade, etc.) may cut one or more discontinuities into at least a portion of the first material. In some embodiments, the cutting apparatus may cut the one or more discontinuities through an entire layer of the first material. In some embodiments, the cutting apparatus may cut the one or more discontinuities through an entire layer of the first material and at least a portion of a layer of a second material (e.g., a soft material described herein). In some embodiments, a deposition apparatus (e.g., an extruder or other apparatus) may heat and/or deposit a predetermined quantity of second material (e.g., the soft material) onto a portion of first material (e.g., rigid material) in a pattern to form at least one discontinuity within the materials. In some embodiments, a deposition apparatus may heat and/or deposit a predetermined quantity of first material (e.g., the rigid material) onto a portion of second material (e.g., soft material) in a pattern to form at least one discontinuity within the materials.

At step 1910, one or more of a molding apparatus, a welding apparatus, a lamination apparatus, or a coextruder may form the second material within the discontinuity of the first material. In some embodiments, a welding apparatus and/or a molding apparatus may heat and inject a portion of the second material into the discontinuities at a temperature in which the second material is at least partially within a molten state and the first material is at least partially in a solid state to integrally form the second material within the discontinuity of the first material. In some embodiments, one or more layers of first material and second material are laminated and/or coextruded together to integrally form the second material within the discontinuity of the first material.

At step 1915, one or more of a die cutting apparatus and/or a stamping apparatus may form a 2D blank having the first material and the second material integrally formed within the discontinuity of the first material. For example, the die cutting apparatus and/or a stamping apparatus may cut a 2D blank having at least the first material and/or the second material into a predetermined size to be thermoformed.

At step 1920, a thermoforming system may thermoform the 2D blank using a dental dentition mold to form the 3D dental aligner to form a 3D dental aligner having spatially variable mechanical properties (e.g., at least variable stiffness). The 3D dental aligner may be cut, trimmed, or otherwise removed from the dental dentition mold after thermoforming for one or more post-processing techniques (e.g., surface coating, grinding, polishing, etc.).

The embodiments described herein have been described with reference to drawings. The drawings illustrate certain details of specific embodiments that provide the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As utilized herein, terms of degree such as “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to any precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that terms such as “exemplary,” “example,” and similar terms, as used herein to describe various embodiments, are intended to indicate that such embodiments are possible examples, representations, or illustrations of possible embodiments, and such terms are not intended to connote that such embodiments are necessarily extraordinary or superlative examples.

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any element on its own or any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the drawings. It should be noted that the orientation of various elements may differ according to other exemplary embodiments, and that such variations are intended to be encompassed by the present disclosure.

As used herein, terms such as “engine” or “circuit” may include hardware and machine-readable media storing instructions thereon for configuring the hardware to execute the functions described herein. The engine or circuit may be embodied as one or more circuitry components including, but not limited to, processing circuitry, network interfaces, peripheral devices, input devices, output devices, sensors, etc. In some embodiments, the engine or circuit may take the form of one or more analog circuits, electronic circuits (e.g., integrated circuits (IC), discrete circuits, system on a chip (SOCs) circuits, etc.), telecommunication circuits, hybrid circuits, and any other type of circuit. In this regard, the engine or circuit may include any type of component for accomplishing or facilitating achievement of the operations described herein. For example, an engine or circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

An engine or circuit may be embodied as one or more processing circuits comprising one or more processors communicatively coupled to one or more memory or memory devices. In this regard, the one or more processors may execute instructions stored in the memory or may execute instructions otherwise accessible to the one or more processors. The one or more processors may be constructed in a manner sufficient to perform at least the operations described herein. In some embodiments, the one or more processors may be shared by multiple engines or circuits (e.g., engine A and engine B, or circuit A and circuit B, may comprise or otherwise share the same processor which, in some example embodiments, may execute instructions stored, or otherwise accessed, via different areas of memory).

Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be provided as one or more suitable processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given engine or circuit or components thereof may be disposed locally (e.g., as part of a local server, a local computing system, etc.) or remotely (e.g., as part of a remote server such as a cloud based server). To that end, engines or circuits as described herein may include components that are distributed across one or more locations.

An example system for providing the overall system or portions of the embodiments described herein might include one or more computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

Although the drawings may show and the description may describe a specific order and composition of method steps, the order of such steps may differ from what is depicted and described. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions, and arrangement of the embodiments without departing from the scope of the present disclosure as expressed in the appended claims.

What is claimed is:

1. A method of forming a dental aligner, the method comprising:
generating a 2D blank configured to form a 3D dental aligner via thermoforming, the 2D blank comprising:
a first material that comprises a first discontinuity; and
a second material integrally formed within the first discontinuity;
wherein the first material comprises a higher stiffness than the second material.

2. The method of claim 1, wherein generating the 2D blank comprises:
receiving the first material;
cutting, by a cutting apparatus, the first discontinuity through at least a portion of the first material; and
at least one of molding or welding the first material with the second material to integrally form the second material within the first discontinuity.

3. The method of claim 1, wherein generating the 2D blank comprises:
receiving the first material;
cutting, by a cutting apparatus, the first discontinuity through at least a portion of the first material; and
laminating the first material with the second material to integrally form the second material within the first discontinuity.

4. The method of claim 1, wherein generating the 2D blank comprises:
receiving the second material;
depositing, by a depositing apparatus, the first material onto the second material in at least two increments to form the first discontinuity; and
laminating the first material with the second material to integrally form the second material within the first discontinuity.

5. The method of claim 1, wherein generating the 2D blank comprises:
receiving a feed of a supply material that comprises the first material and the second material laminated together;
cutting, by a cutting apparatus, the first discontinuity through an entirety of the supply material; and
molding the supply material, wherein molding the supply material causes at least a portion of the second material to melt into the first discontinuity to integrally form the second material within the first discontinuity.

6. The method of claim 5, wherein the supply material is molded at a temperature in which the second material at least partially reaches a molten state and in which the first material at least partially remains at a solid state.

7. The method of claim 1, wherein generating the 2D blank comprises:
receiving the first material;
cutting, by a cutting apparatus, the first discontinuity into the first material;
receiving the second material; and
laminating the first material and the second material together to integrally form the second material within the first discontinuity.

8. The method of claim 6, wherein generating the 2D blank further comprises:
receiving at least one adhesive material; and
laminating the at least one adhesive material with the first material and the second material.

9. The method of claim 1, wherein generating the 2D blank comprises:
receiving a supply material that comprises the first material coextruded with the second material; and
cutting, by a cutting apparatus, the first discontinuity into the first material.

10. A 2D blank for forming a 3D dental aligner, the 2D blank comprising:
a first material that comprises a first discontinuity;
a second material integrally formed within the first discontinuity;
wherein the first material comprises a higher stiffness than the second material; and
wherein the 2D blank is configured to be thermoformed to form the 3D dental aligner.

11. The 2D blank of claim 10, wherein the first material and the second material form one continuous single-ply sheet of material.

12. The 2D blank of claim 10, wherein:
the first material and the second material form a plurality of layers of the 2D blank; and
the 2D blank is configured to be thermoformed to form the 3D dental aligner such that the 3D dental aligner is multi-layered and made of at least two materials.

13. The 2D blank of claim 10, wherein the first material and the second material are integrally formed by at least one of lamination, molding, or coextrusion.

14. The 2D blank of claim 10, wherein:
a first portion of the 2D blank comprises a first thickness;
a second portion of the 2D blank comprises a second thickness; and
the first thickness differs from the second thickness.

15. The 2D blank of claim 10, further comprising an identification marking located on at least one of a portion of the first material or a portion of the second material.

16. A system comprising:
a cutting apparatus configured to form a first discontinuity through at least a portion of a first material;
a stamping apparatus configured to cut a 2D blank out of the first material; and
a molding apparatus configured to integrally mold a second material into the first discontinuity of the 2D blank;
wherein the first material comprises a higher stiffness than the second material; and
wherein the 2D blank is configured to be thermoformed to form a 3D dental aligner.

17. The system of claim 16, wherein the cutting apparatus comprises at least one of a laser, a mill, a blade, or a die cutter.

18. The system of claim 16, wherein the stamping apparatus comprises at least one of a stamping press or a die cutter.

19. The system of claim 16, wherein the molding apparatus includes a first mold plate and a second mold plate configured to clamp the 2D blank and inject the second material into the first discontinuity.

20. The system of claim 16, wherein the 2D blank comprises a single-ply sheet of a combination of the first material and the second material.
